(19) United States
(12) Patent Application Publication
(10) Pub. No.: US 2023/0161775 A1
(43) Pub. Date: May 25, 2023

(54) NON-TEXTUAL HASHTAG CREATION FOR NON-TEXTUAL CONTENT

(71) Applicant: INTERNATIONAL BUSINESS MACHINES CORPORATION, Armonk, NY (US)

(72) Inventors: Shikhar Kwatra, San Jose, CA (US); Jeremy R. Fox, Georgetown, TX (US); Vijay Ekambaram, Chennai (IN); Sarbajit K. Rakshit, Kolkata (IN); John D. Wilson, League City, TX (US); Venkata Vara Prasad Karri, Visakhapatnam (IN)

(21) Appl. No.: 17/531,346

(22) Filed: Nov. 19, 2021

(51) Int. Cl. G06F 16/2457

(52) U.S. Cl. CPC G06F 16/24575

(57) ABSTRACT

A computer-implemented process within a tagging system configured to be executed on a computer hardware system includes the following operations. An identification of non-textual content being accessed by the user is received from a client tagging module within a client device associated with a user. A contextual analysis of the non-textual content is performed, using an object identification engine of the tagging system, to identify attributes of the non-textual content. An identification of the non-textual hashtag is stored as a data structure in association with the non-textual content and at least one of the attributes and the non-textual content. A search is performed for additional non-textual content related to the non-textual content based upon a selection of the non-textual hashtag.

### BACKGROUND

The present invention relates to tagging digital non-textual content with metadata, and more specifically, to recommending and creating non-textual hashtags for digital non-textual content.

Hashtags are a type of label or metadata tag used to tag specific content. In operation, a user creates a hashtag by placing the hash or pound sign (i.e., “#”) in front of textual information such as a word or unspaced phrase. The hashtag acts as metadata describing the content to which the hashtag is associated. In operation, a user tags particular content with a hashtag, and that hashtag can be used by both the user and other users to identify other content that is associated with the same hashtag. In this manner, the hashtag acts as a lightweight, seamless tag that does not require a formal taxonomy or markup language to employ.

Hashtags, however, are limited in their descriptiveness to the textual information being presented as a word or unspaced phrase. Certain pieces of content cannot be adequately described using a text-based keyword. This lack of descriptiveness can limit their applicability to only a certain subset of the content that is capable of being tagged.

### SUMMARY

A computer-implemented process within a tagging system configured to be executed on a computer hardware system includes the following operations. An identification of non-textual content being accessed by the user is received from a client tagging module within a client device associated with a user. A contextual analysis of the non-textual content is performed, using an object identification engine of the tagging system, to identify attributes of the non-textual content. An identification of the non-textual hashtag is stored as a data structure in association with the non-textual content and at least one of the attributes and the non-textual content. A search is performed for additional non-textual content related to the non-textual content based upon a selection of the non-textual hashtag.

The computer-implemented process can further includes the user providing the non-textual hashtag via the client tagging module. Additionally, the client tagging module is configured to permit the user to associate the non-textual hashtag within a particular one of the attributes. As an alternative, the non-textual hashtag can be automatically generated based upon at least one of the attributes using a joint embedding model that is applied to at least one of the attributes. The non-textual hashtag can also include a textual portion. In certain aspects, the non-textual content is a video and the non-textual hashtag is an image.

A computer hardware system having a tagging system includes a hardware processor configured to perform the following executable operations. An identification of non-textual content being accessed by the user is received from a client tagging module within a client device associated with a user. A contextual analysis of the non-textual content is performed, using an object identification engine of the tagging system, to identify attributes of the non-textual content. An identification of the non-textual hashtag is stored as a data structure in association with the non-textual content and at least one of the attributes and the non-textual content. A search is performed for additional non-textual content related to the non-textual content based upon a selection of the non-textual hashtag.

The computer hardware system can further include the user providing the non-textual hashtag via the client tagging module. Additionally, the client tagging module is configured to permit the user to associate the non-textual hashtag within a particular one of the attributes. As an alternative, the non-textual hashtag can be automatically generated based upon at least one of the attributes using a joint embedding model that is applied to at least one of the attributes. The non-textual hashtag can also include a textual portion. In certain aspects, the non-textual content is a video and the non-textual hashtag is an image.

A computer program product includes a computer readable storage medium having stored therein program code. The program code, which when executed by a computer hardware system including a tagging system, cause the computer hardware system to perform the following. An identification of non-textual content being accessed by the user is received from a client tagging module within a client device associated with a user. A contextual analysis of the non-textual content is performed, using an object identification engine of the tagging system, to identify attributes of the non-textual content. An identification of the non-textual hashtag is stored as a data structure in association with the non-textual content and at least one of the attributes and the non-textual content. A search is performed for additional non-textual content related to the non-textual content based upon a selection of the non-textual hashtag.

The computer program product can further include the user providing the non-textual hashtag via the client tagging module. Additionally, the client tagging module is configured to permit the user to associate the non-textual hashtag within a particular one of the attributes. As an alternative, the non-textual hashtag can be automatically generated based upon at least one of the attributes using a joint embedding model that is applied to at least one of the attributes. The non-textual hashtag can also include a textual portion. In certain aspects, the non-textual content is a video and the non-textual hashtag is an image.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example content management system architecture for creating, editing, managing, and maintaining content, such as non-textual content, according to an aspect of the present invention.

FIG. 2 is a block diagram illustrating an example tagging system 110 for use with the content management system illustrated in FIG. 1., according to an aspect of the present invention.

FIG. 3 is a block diagram illustrating an example method of generating non-textual hashtags using the architecture illustrated in FIGS. 1, 2, according to an aspect of the present invention.

FIGS. 4A and 4B respectively illustrate visual content with displayed associated attributes and non-textual tags according to an aspect of the present invention.

FIGS. 5A and 5B respectively illustrate visual content with displayed associated attributes according to an aspect of the present invention.

FIG. 6 is a block diagram illustrating an example of computer hardware system for implementing the tagging system of FIG. 2.

FIG. 7 depicts a cloud computing environment according to an embodiment of the present invention.

FIG. 8 depicts abstraction model layers according to an embodiment of the present invention.

### DETAILED DESCRIPTION

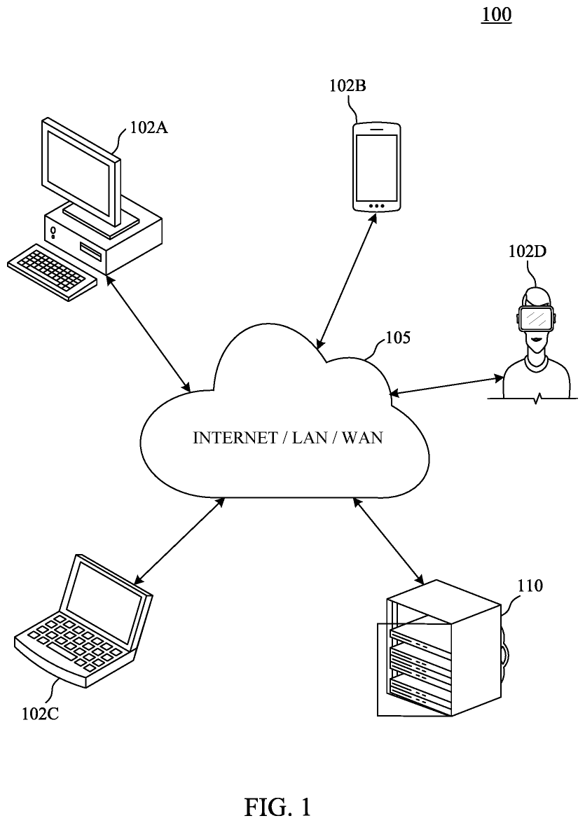

Reference is made to FIGS. 1-3, which respectively illustrate an architecture 100, 110 and methodology 300 for generating and using a non-textual hashtag for use with non-textual content. As used herein, the term “non-textual hashtag” means a hashtag that includes a representation in something other than text. This definition does not exclude the non-textual hashtag from including text but if the non-textual hashtag does include text, the non-textual hashtag must also include a non-textual component that is perceivable by a user. For example, the non-textual component can be a static image, audio, and/or video. As another example, the non-textual component can include sensatory information, such as a particular sound or tactile sensation. Although typical hashtags use the hash or pound sign (i.e., “#”) as a special delimiter to signal the beginning of the hashtag, the present non-textual hashtag can use another special character (e.g., a double hash, i.e., “##” or caret, i.e., “^”) as a special delimiter to signal the beginning of the present non-textual hashtag.

As defined herein, the term “non-textual content” means digitally-stored, non-textual content such as images, audio, and video. Consistent with the use of conventional hashtags, the disclosed non-textual hashtag serves as metadata that is used to describe the non-textual content with which the non-textual hashtag is associated.

Referring to FIG. 1, a tagging system 110 is electronically connected to various client devices 102A-D via a network 105, such as the internet, local area network (LAN), and/or wide area network (WAN). The combination of the tagging system 110 and the client devices 102A-D is a content management system 100, which can allow users to create, edit, manage, and maintain content, such as non-textual content. Although not limited in this manner, the content management system 100 can be configured to permit a company/organization to build websites for themselves and their clients by streamlining web design and content publishing.

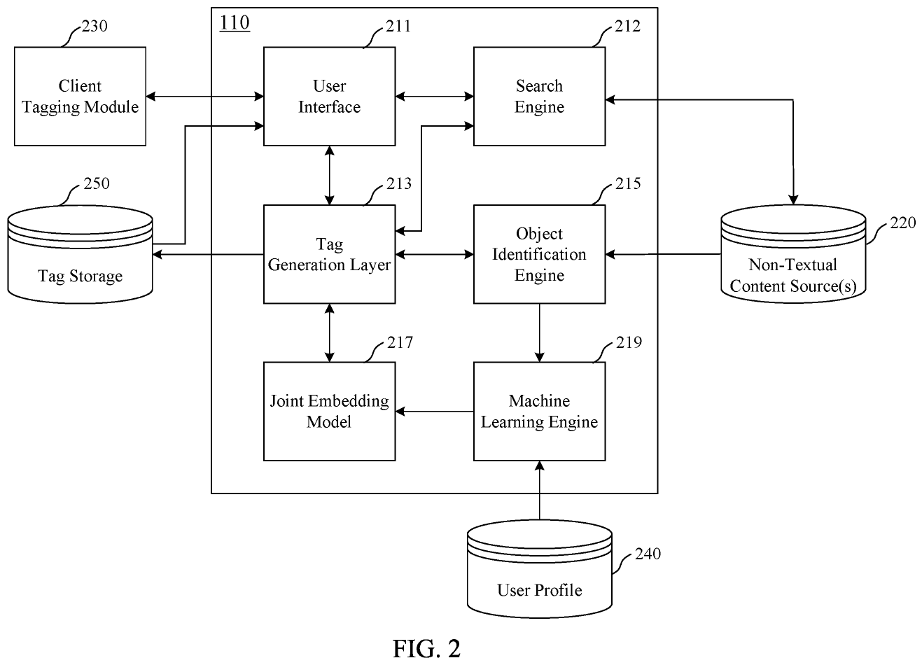

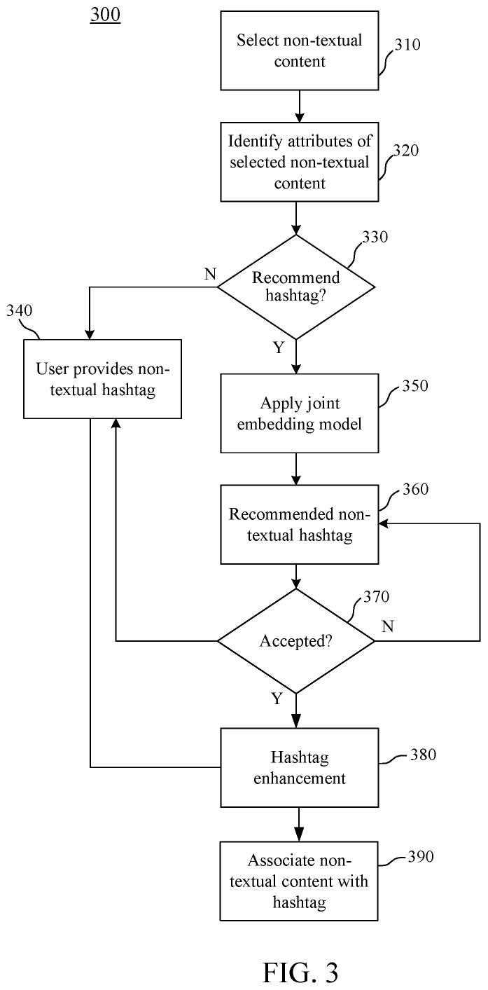

Referring to FIG. 2, each of the client devices 120A-D can include a client tagging module 230 that interacts with the tagging system 110 via a user interface 211. Although the tagging system 110 is depicted as including certain functional components, one or more of these functional components can be distributed externally, e.g., in the cloud, and/or be included in the client devices 102A-D—for example, as part of the client tagging module 230. Additionally, while storage devices 220, 240, 250 are illustrated as being separate from the tagging system 110, one or more of these storage devices 220, 240, 250 can be included within the tagging system 110 and/or client tagging modules 230. The operation of the tagging system 110 is discussed in more detail with regard to FIG. 3.

A joint embedding model 217 is a known technology associated with machine learning. In machine learning, an embedding is a vector representation that represents an entity. For example, in natural language processing, embedding of words (i.e., word embedding) is used generate vectors representing the individual words such that words closer in vector space are expected to have similar meanings. With a joint embedding model 217, more than a single modality (e.g., both words and pictures) can both be represented as vectors in a multimodal space. As such, in using a joint embedding model 217, one or more words (e.g., query tag(s)/keyword(s)) can be used to search for an image, a query image can be used to retrieve one or more words describing an image, and/or a query image can be used to identify similar images. In certain aspects, the present joint embedding model 217 can also include additional modalities such as video and audio. The tagging system 110 is not limited as to a particular type of joint embedding model 217 so capable.

Referring to FIG. 3, an exemplary method of applying a non-textual hashtag to non-textual content using the tagging system 110 is disclosed. In 310, a user selects, using a client tagging module 230, non-textual content to be associated with the non-textual hashtag. In the situation of a static image, the user can select the whole image or just a portion thereof. For example, the client tagging module 230 can be configured to allow the user select a specific area of the image. Additionally, in the content of a video, the client tagging module 230 can present the user with the option of selecting the entire video or a portion thereof. For example, the client tagging module 230 can be configured to allow a time range of the video to be selected.

Although selection of the non-textual content can be performed upon the direction of the user, the tagging system 110 can automatically select the non-textual content for the creation of a non-textual hashtag. By way of example, the tagging system 110 can detect that Amy is watching a cooking-related video that employs a new cooking technology on her mobile phone 102B. Based upon this detection, the tagging system 110 can automatically select the accessed non-textual content and auto-suggest a proposed non-textual hashtag to be used with the accessed non-textual content. The tagging system 110 can also present Amy with related media based upon the auto-suggested non-textual hashtag.

In addition, the tagging system 110 can be configured to automatically select the non-textual hashtag based upon Amy's user profile 240. For example, Amy's user profile 240 indicates that Amy enjoys “cooking” and “technology.” The tagging system 110, recognizing that the accessed non-textual content matches Amy's preferences in the user profile 240, can then automatically propose a particular non-textual hashtag based upon the match. Additionally, the tagging system 110 can be configured to real-time monitor more than a single source of content being accessed by the user. For example, while Amy may be viewing a cooking-related video on her mobile phone 102B, the tagging system 110 may also recognize that Amy is searching for recipes on her laptop 102C and provide suggested non-textual hashtags based upon both sources of content. Additionally, the identification of the content being accessed by the user can include content that is viewed, content that is listened to, as well as content that is captured or shared.

In 320, a contextual analysis is performed on the selected non-textual content to identify attributes of the selected non-textual content. For example, an object identification engine 240 of the tagging system 110 can be used to detect discrete objects within the non-textual content. The tagging system 110 is not limited as to the particular technology used to implement the object identification engine 215 as many existing technologies so capable exist.

Although not limited in this manner, in certain aspects of the tagging system 110, the object identification engine 215 employs a conventional neural network (CNN), which is a type of artificial neural network used in image processing and recognition. A conventional CNN employs a convolutional layer, a pooling layer, and a full connected layer. The convolutional layer abstracts the non-textual content as a feature map. The pooling layer downsamples the feature map via the summarization of the presence of features in portions of the feature map. The fully connected layer connects individual nodes (i.e., “neurons”) in the other layers. A R-CNN (or RCNN) refers to a Region-Based CNN. In this variation, bounding boxes are used in object regions, which can be used to classify multiple image regions of the non-textual content. Mask R-CNN builds upon Faster R-CNN and provides, as outputs, for each candidate object, a class object, a bounding-box offset, and an object mask.

The discrete objects, once identified, are then classified (e.g., labeled) by the object identification engine 215. The labels of the discrete objects within the selected non-textual content can be used as metadata, to be stored in association with the non-textual hashtag and the selected content, that represent attributes of the selected content. Additionally, the contextual analysis can also identify characteristics/attributes of the individual objects themselves, which can also be included as metadata of the selected content. As illustrative examples, a “road” can be characterized as “hilly” and an “automobile” can be characterized, using a motion analysis, as “moving.”

In 330, a determination is made whether to automatically recommend a non-textual hashtag. This determination can be based, for example, on how the non-textual content was selected. For example, if the non-textual content was automatically selected without intervention by the user, then the tagging system 110 may proceed to the operations 350-370, which involve the automatic recommendation of a non-textual hashtag. Alternatively, if the non-textual content was selected by the user with the client tagging module 230, the client tagging module 230 can be configured to present the user with an option to either receive a recommended non-textual hashtag (e.g., operations 350-370) or for the user to provide the non-textual hashtag.

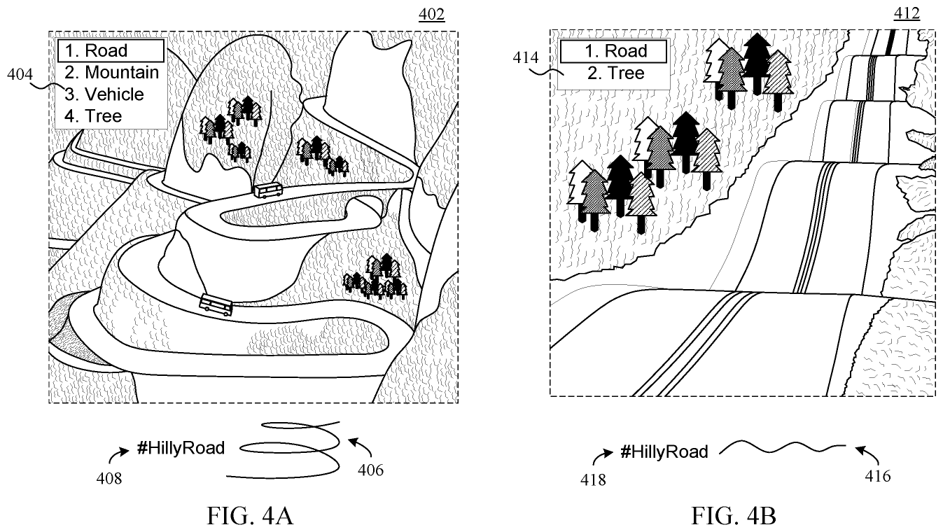

In 340, upon the user selecting to provide the non-textual hashtag, the client tagging module 230 is configured to permit the user to provide an image or video that will serve as the non-textual hashtag. The client tagging module 230 is not limited in the manner by which the non-textual hashtag is provided. For example, the client tagging module 230 can be configured to permit a file (e.g., the non-textual hashtag) to be uploaded to the user interface 211 of the tagging system 110 and/or permit the user to provide an address from which the non-textual hashtag can be retrieved. Additionally, the client tagging module 230 can permit the user to create the non-textual hashtag by providing access to a drawing program that will permit the user to draw the non-textual hashtag. For example, and with reference to FIGS. 4A, 4B, non-textual hashtags of a helical shape 406 and a wavy line 416 can represent a non-textual hashtag associated with pictures 402, 412 of a hilly road. Additionally, the client tagging module 230 can permit the non-textual hashtag to be associated with a particular attribute of the image 402, 412. For example, in both FIGS. 4A, 4B, the user has selected the attribute of “1. Road” to be associated with the non-textual hashtags of a helical shape 406 and a wavy line 416.

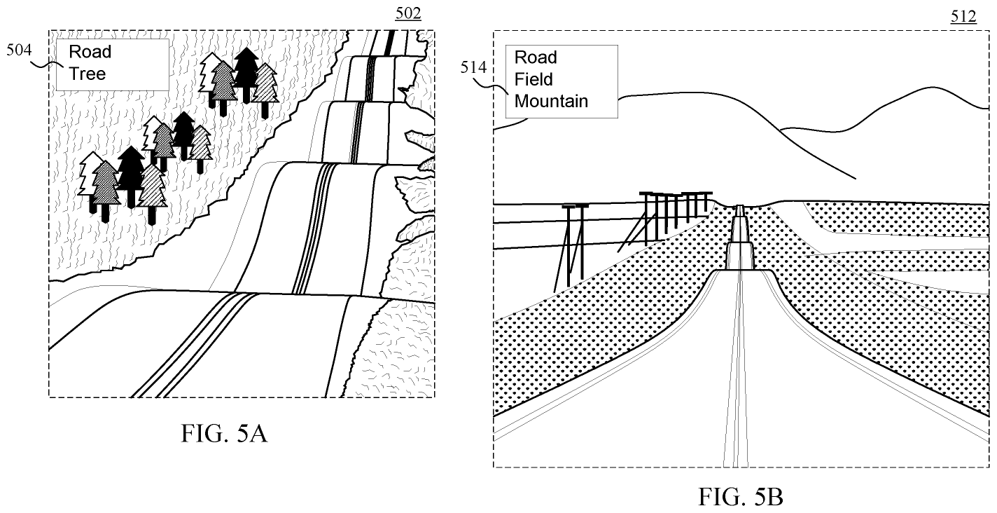

As another example, in the situation of a user is watching car racing in a video file, the user wants to create a non-textual hashtag of a speeding car. In so doing, the user can identify another video of speeding car and tag this other video with the speeding car of the first video. Thus, the user finds that the movement pattern of car in first video is similar to the movement pattern car in second video and the user creates the non-textual hashtag using the second video. An example of this is illustrated with respect to FIGS. 5A, 5B. In this instance, the image 502 of

FIG. 5A is to receive a non-textual hashtag. In this instance, the user can use an attribute 504 (i.e., Road) of one image 502, to create a non-textual hashtag for an attribute 514 (i.e., Road) of another image 512.

Although much of the discussion herein relates to non-textual hashtags being visual (e.g., an image or a video), the tagging system 110 is not limited in this manner. For example, the tagging system 110 can generate other types of non-textual hashtags. For example, the non-textual hashtag could be audio (e.g., a spoken word or expression), tactile sensation (e.g., a physical interaction with the environment), or movement of the body. These other forms of non-textual hashtags can be received by the client devices 102A-D, in a variety of different manners. Although not limited in this manner, a speaker can receive audio and a video camera and/or pressure sensor can perceive human movement or physical interaction with an environment. Examples of human movement can include sign language (ASL), physical gestures, facial movement, eye movement, and other computer-perceptible human movement/interaction.

For example, a storm seen in a video can be provided with the non-textual hashtag of air blown from the mouth. Alternatively, a strong held object in a video can associated with a non-textual hashtag of squeezing a pressure sensor. As such, if the user would like to search for media content having storm scenes, the user could blow air from the user's mouth. These alternative non-textual hashtags can be particularly useful for impaired users. For example, a user that is visually impaired may not be able to perceive a visual, non-textual hashtag.

In 350, once the metadata representing attributes of the selected non-textual content is obtained, this metadata can be used with the machine learning engine 219, the joint embedding model 217, and the tag generation layer 213 to generate/identify potential non-textual hashtags to be recommended to the user. The machine learning engine 219 can be a neural network that uses information stored within the user profile 240 to place weights on the identified attributes associated with the selected visual content. As discussed above with regard to the example of Amy, Amy's user profile 240 indicates that Amy enjoys “cooking” and “technology.” The machine learning engine 219, for example, can use these preferences to give higher weight to attributes associated with both “cooking” and “technology.” This is reflected in the joint embedding model 217 in which the dimensions of the vector respectively associated with the identified preferences are given a higher weight.

Additionally, the machine learning engine 219 can use information from the user (either directly provided or indirectly observed) to apply weights. For example, as illustrated in FIGS. 4A, 4B, attributes 404, 414 for the images 402, 412 can be presented to the user via the client tagging module 230, and the selection of one or more of these attributes 404, 414 by the user can be used to increase the weighting for the selection. An example of an indirect observation involves John is watching a baseball match on his mobile phone 102B and is talking to his son about the material used for “baseball.” The tagging system 110 can perform a gaze analysis to understand that the user, i.e., John, is watching baseball and considers the input audio message “baseball” +“material” and use this information as attributes/dimensions. This additional information could be obtained using, for example, smart contact lens or from XR (extended reality) glasses 102D.

The tag generation layer 213, in conjunction with the joint embedding model 217, generates/identifies and ranks a plurality of proposed non-textual hashtags. As discussed above, the joint embedding model 217 is a known technology that allows for different modalities (e.g., words, images, video, audio) to be represented as vectors in the same multi-modal space. The tag generation layer 213 can use the attributes (and weights associated therewith generated by the machine learning engine 219) as word(s) in the joint embedding model 217 to generate/identify the plurality of potential non-textual hashtags to be recommended to the user.

The tagging system 110 is not limited as to a particular approach to rank the proposed non-textual hashtags. However, in certain aspects, the tagging system 110 employs k-means clustering to rank the non-textual hashtags. Additionally, the tagging system 110 can use cosine distance between the vectors represented in the joint embedding model 217 instead of Euclidean distance as a distance metric in the k-means clustering. Again, other clustering approaches are known and can be applied to ranking the proposed-non-textual hashtags. However, regardless of the approach, those vectors associated with the non-textual hashtags that are determined to be closer to the vector representing the viewed content have a higher ranking.

In 360, the highest-ranked non-textual hashtag is presented to the user via the client tagging module 230. Alternatively, a plurality of high-ranking non-textual hashtag are presented to the user via the client tagging module 230. If, in 370, the client accepts, via the client tagging module 230, one of the non-textual hashtag(s) being presented, then the process proceeds to 380. Otherwise, the processing loops to operation 360, in which one or more additional high-ranking no-textual hashtags are identified and presented to the user until the user accepts a particular non-textual hashtag to be used with the non-textual content. As another alternative, the methodology can proceed to operation 340, in which the user can provide the non-textual hashtag, as already discussed above. If the user selects one of the suggested non-textual hashtag, this selection can be used as feedback to modify one or both of the user profile 240 or joint embedding model 217 to subsequently reduces the cosine distance (i.e., a measure of similarity) between the selected non-textual content and the

In 380, the client tagging module 230 can be configured to permit the user to enhance the non-textual hashtag using the tag generation layer 213. There are multiple different techniques for enhancing the non-textual hashtag, and any single technique or different combination of techniques can be employed. One technique involves adding a textual hashtag to the non-textual hashtag. For example, with reference to FIGS. 4A, 4B, the client tagging module 230 can provide the textual hashtag 408, 418 of “#HillyRoad” to the non-textual hashtag 406, 408. This combination of textual hashtag and non-textual hashtag, as defined herein, results in a non-textual hashtag.

Another approach to enhancing the non-textual hashtag is to add attributes, as metadata, that will be stored in association with the non-textual hashtag and the selected non-textual content. The client tagging module 230 is not limited as to the particular type(s) of attributes that can be added to the non-textual hashtag or the manner by which these attribute(s) are added. For example, if not already performed, the client tagging module 230, in conjunction with the tag generation layer 213, can cause a contextual analysis of the selected non-textual content to be performed using the object identification engine 215 (as discussed with regard to 320) to identify attributes of the selected non-textual content. Once identified, these attributes can be presented to the user using the client tagging module 230. For example, with reference to FIGS. 4A, 4B, the client tagging module 230 can provide attributes 404, 414, respectively associated with non-textual content 402, 412. The client tagging module 230 permits one or more of the attributes 404, 414 to be selected and subsequently associated with the non-textual hashtag.

In 390, the tag generation layer 213 stores, as a data structure, an identification of the non-textual hashtag in association with the selected non-textual content, at least one of the attributes of the non-textual content, and any additional hashtag enhancements. For example, this information can be stored within a tag storage device 250 of the tagging system 110. Once created, the non-textual hashtag can be associated, e.g., based upon data stored within the tag storage 250 and/or the user profile 240, with a particular user. In addition to or alternatively, the tagging system 110 can permit other users of the tagging system 110 to have access to the non-textual hashtag. Although not limited in this manner, the implementation of the non-textual hashtag can include, after the special delimiter, a pointer to the data stored within the tag storage device 250. In this manner, the stored information associated with the non-textual hashtag can be retrieved from the tag storage device 250. Additionally, where the pointer is included in a website (or similar content), the content management system 100 can cause the non-textual tag to be displayed in place of the pointer. The data associated with the non-textual tag and stored within the tag storage device 250 can include a modified UUID (universally unique identifier) that can be used as part of an index.

Similar to the use of conventional hashtags, once the non-textual hashtag has been created and, selection of the non-textual hashtag can be used to initiate a search for visual media from non-textual content sources 220. that is consistent with the non-textual hashtag. This search of the non-textual content sources 220 can be performed by a search engine 212 of non-textual content source(s) 220 using the added attributes that were associated as metadata to the non-textual hashtag. In addition to or alternatively, the tagging system 110 can apply the joint embedding model 217 to the non-textual hashtag to identify attributes of the non-textual hashtag that can also be used as a basis of the search, using the search engine 212, of the non-textual content sources 220. The result of this search (indications of additional visual media related to the non-textual hashtag) can then be provided via the user interface 211 to the client tagging module 230 of the requesting user.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “server” means a data processing system configured to share services with one or more other data processing systems.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

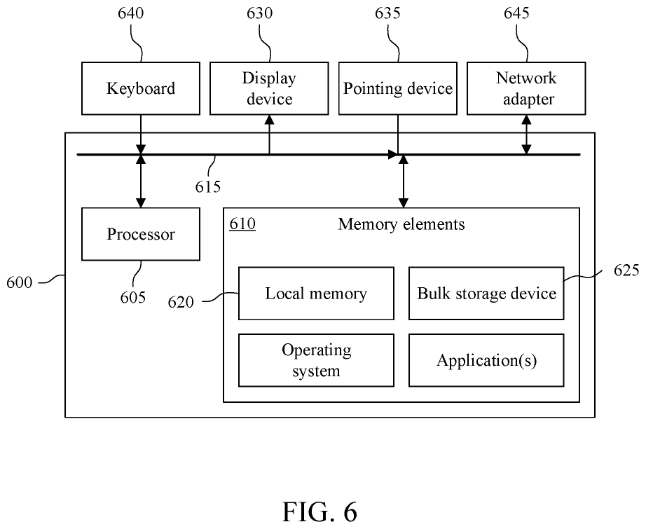

FIG. 6 is a block diagram illustrating example architecture for a data processing service 600 for executing the tagging system 110. The data processing system 600 can include at least one processor 605 (e.g., a central processing unit) coupled to memory elements 610 through a system bus 615 or other suitable circuitry. As such, the data processing system 600 can store program code within the memory elements 610. The processor 605 can execute the program code accessed from the memory elements 610 via the system bus 615. It should be appreciated that the data processing system 600 can be implemented in the form of any system including a processor and memory that is capable of performing the functions and/or operations described within this specification. For example, the data processing system 600 can be implemented as a server, a plurality of communicatively linked servers, a workstation, a desktop computer, a mobile computer, a tablet computer, a laptop computer, a netbook computer, a smart phone, a personal digital assistant, a set-top box, a gaming device, a network appliance, and so on.

The memory elements 610 can include one or more physical memory devices such as, for example, local memory 620 and one or more bulk storage devices 625. Local memory 620 refers to random access memory (RAM) or other non-persistent memory device(s) generally used during actual execution of the program code. The bulk storage device(s) 625 can be implemented as a hard disk drive (HDD), solid state drive (SSD), or other persistent data storage device. The data processing system 600 also can include one or more cache memories (not shown) that provide temporary storage of at least some program code in order to reduce the number of times program code must be retrieved from the local memory 620 and/or bulk storage device 625 during execution.

Input/output (I/O) devices such as a display 630, a pointing device 635 and, optionally, a keyboard 640 can be coupled to the data processing system 600. The I/O devices can be coupled to the data processing system 600 either directly or through intervening I/O controllers. For example, the display 630 can be coupled to the data processing system 600 via a graphics processing unit (GPU), which may be a component of the processor 605 or a discrete device. One or more network adapters 645 also can be coupled to data processing system 600 to enable the data processing system 600 to become coupled to other systems, computer systems, remote printers, and/or remote storage devices through intervening private or public networks. Modems, cable modems, transceivers, and Ethernet cards are examples of different types of network adapters 645 that can be used with the data processing system 600.

As pictured in FIG. 6, the memory elements 610 can store the components of the tagging system 110 of FIG. 2. Being implemented in the form of executable program code, these components of the data processing system 600 can be executed by the data processing system 600 and, as such, can be considered part of the data processing system 600.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

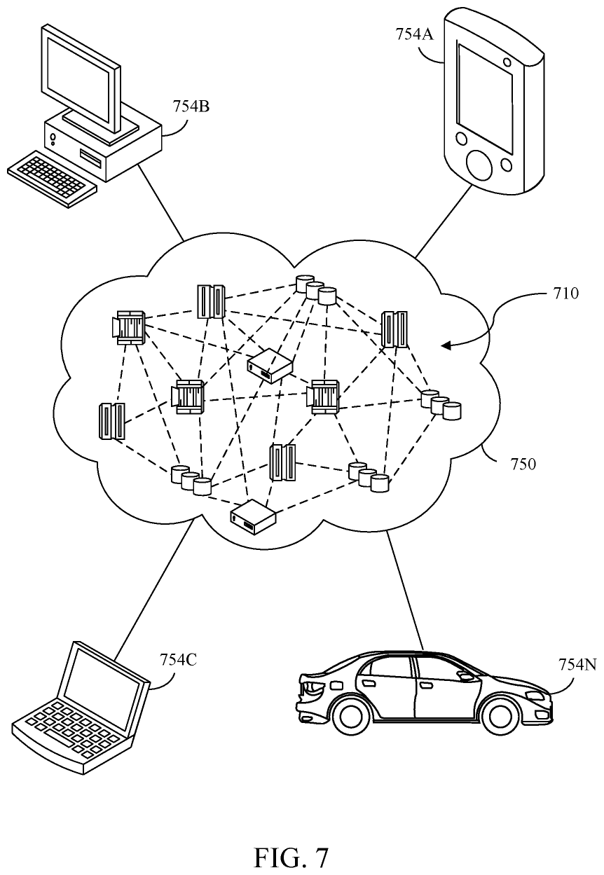

Referring now to FIG. 7, illustrative cloud computing environment 750 to be used with the tagging system is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

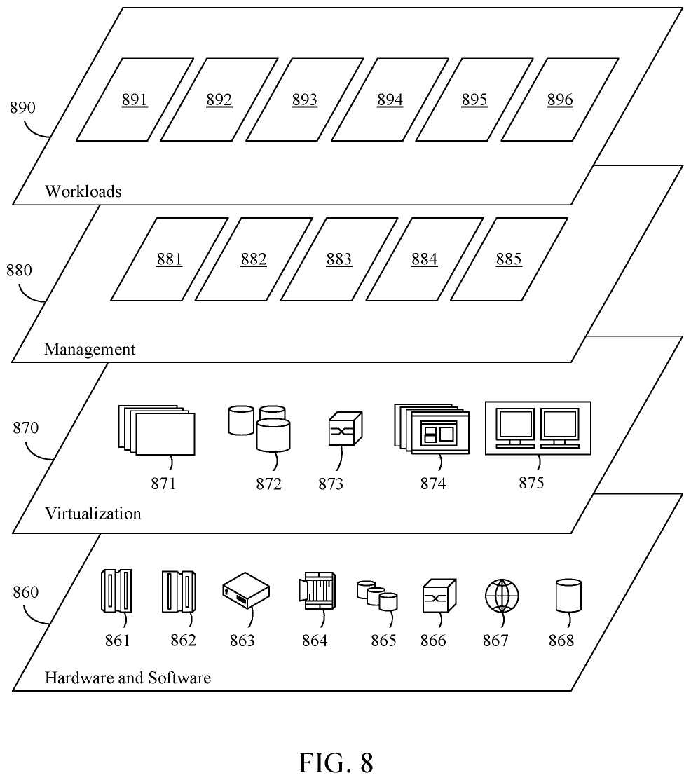

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and operations of the tagging system 896.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

1. A computer-implemented process within a tagging system configured to be executed on a computer hardware system, comprising:
receiving, from a client tagging module within a client device associated with a user, an identification of non-textual content being accessed by the user;
performing, using an object identification engine of the tagging system, a contextual analysis of the non-textual content to identify attributes thereof;
storing, as a computer data structure, an identification of a non-textual hashtag in association with the non-textual content and at least one of the attributes and the non-textual content; and
performing a search for additional non-textual content related to the non-textual content based upon a selection of the non-textual hashtag.

2. The method of claim 1, wherein
the user provides the non-textual hashtag via the client tagging module.

3. The method of claim 1, wherein
the client tagging module is configured to permit the user to associate the non-textual hashtag with a particular one of the attributes.

4. The method of claim 1, wherein
the non-textual hashtag is automatically generated based upon at least one of the attributes.

5. The method of claim 4, wherein
the non-textual hashtag is automatically generated using a joint embedding model that is applied to at least one of the attributes.

6. The method of claim 1, wherein
the non-textual hashtag includes a textual portion.

7. The method of claim 1, wherein
the non-textual content is a video and the non-textual hashtag is an image.

8. A computer hardware system including a tagging system, comprising:
a hardware processor configured to perform the following executable operations:
receiving, from a client tagging module within a client device associated with a user, an identification of non-textual content being accessed by the user;
performing, using an object identification engine of the tagging system, a contextual analysis of the non-textual content to identify attributes thereof;
storing, as a computer data structure, an identification of a non-textual hashtag in association with the non-textual content and at least one of the attributes and the non-textual content; and
performing a search for additional non-textual content related to the non-textual content based upon a selection of the non-textual hashtag.

9. The system of claim 8, wherein
the user provides the non-textual hashtag via the client tagging module.

10. The system of claim 8, wherein
the client tagging module is configured to permit the user to associate the non-textual hashtag with a particular one of the attributes.

11. The system of claim 8, wherein
the non-textual hashtag is automatically generated based upon at least one of the attributes.

12. The system of claim 11, wherein
the non-textual hashtag is automatically generated using a joint embedding model that is applied to at least one of the attributes.

13. The system of claim 8, wherein
the non-textual hashtag includes a textual portion.

14. The system of claim 8, wherein
the non-textual content is a video and the non-textual hashtag is an image.

15. A computer program product, comprising:
a computer readable storage medium having stored therein program code,
the program code, which when executed by a computer hardware system including a tagging system, cause the computer hardware system to perform:
receiving, from a client tagging module within a client device associated with a user, an identification of non-textual content being accessed by the user;
performing, using an object identification engine of the tagging system, a contextual analysis of the non-textual content to identify attributes thereof;
storing, as a computer data structure, an identification of the non-textual hashtag in association with the non-textual content and at least one of the attributes and the non-textual content; and
performing a search for additional non-textual content related to the non-textual content based upon a selection of the non-textual hashtag.

16. The computer program product of claim 15, wherein
the user provides the non-textual hashtag via the client tagging module.

17. The computer program product of claim 15, wherein
the client tagging module is configured to permit the user to associate the non-textual hashtag with a particular one of the attributes.

18. The computer program product of claim 15, wherein
the non-textual hashtag is automatically generated based upon at least one of the attributes.

19. The computer program product of claim 18, wherein
the non-textual hashtag is automatically generated using a joint embedding model that is applied to at least one of the attributes.

20. The computer program product of claim 15, wherein
the non-textual hashtag includes a textual portion.
